(19) United States
(12) Patent Application Publication
(10) Pub. No.: US 2007/0253443 A1
(43) Pub. Date: Nov. 1, 2007

(54) Data services over G.SHDSL transport infrastructure

(75) Inventors: Douglas W. Dean JR., San Antonio, TX (US); Craig Riley, San Antonio, TX (US)

Correspondence Address: PAUL S MADAN;MADAN, MOSSMAN & SRIRAM, PC, 2603 AUGUSTA DRIVE, SUITE 700, HOUSTON, TX, 77057-5662, US

(73) Assignee: SBC Knowledge Ventures L.P., Reno, NV (US)

(21) Appl. No.: 11/412,455

(22) Filed: Apr. 27, 2006

(51) Int. Cl. H04J 3/22

(52) U.S. Cl. 370/465; 370/401

(57) ABSTRACT

The present disclosure provides a system, method and computer-readable medium for providing a network service. In one aspect, the disclosure provides a system for providing a network service that includes a network device for providing the network service over a network loop using Symmetric High Bit Rate Digital Subscriber Loop (G.SHDSL) as a transport mechanism over the network loop; and a network-capable access device that terminates the network loop.

### BACKGROUND OF THE DISCLOSURE

1. Field of the Disclosure

The present disclosure relates to providing network services over a Symmetric High Bit Rate Digital Subscriber Loop (G.SHDSL).

2. Description of the Related Art

Broadband communication networks provide network services, such as Frame Relay, to customer locations over loops connecting the network to the customers. Each loop supports a transmission standard used in transporting the network services. A commonly used transmission standard is Digital Signal Level 1 (DS-1) which transmits data at 1.544 Megabits per second (Mbps). Many small and medium-sized businesses currently use a DS-1 connection to transmit signals to and from a network edge device, such as a 3/1 Digital Cross-Connect System (3/1 DCS), an electronic cross-connect device for directing and re-directing circuits. Networks that support customer DS-1 connections generally require several network elements, such as multiplexers and the abovementioned digital cross-connect devices (i.e. 3/1 DCS) to provide data transportation between the network edge device and, for example, an ATM switch connecting the network to an Asynchronous Transfer Mode (ATM) network. These network elements are generally expensive to install and to operate.

Symmetric High Bit Rate Digital Subscriber Loop, referred to as G.SHDSL, is a standard for single-pair high-speed DSL connections. G.SHDSL provides a symmetrical connection that offers the same bandwidth in both the upstream (to the central office) and downstream (to the customer) directions. G.SHDSL currently offers multiple data rates, including 786 Kbit/sec, 1.544 Mbit/sec and 2.3 Mbit/sec and may be implemented over several types of wire connections, including a single pair (2-wire), double pair (4-wire), etc. G.SHDSL may be used as a service (or pipe), operating over existing customer lines, but then the G.SHDSL services compete with other services provided, for example, over the DS-1 transmission standard. Alternately, G.SHDSL may be used as a transport mechanism (a transmission standard operating internal to the network), thereby avoiding competition issues. Additionally, using G.SDHSL as a transport mechanism enables a new network structure for delivering services that operates without employing additional expensive network elements, such as the 3/1 DCS.

### BRIEF DESCRIPTION OF THE DRAWINGS

For detailed understanding of the present disclosure, references should be made to the following detailed description of an exemplary embodiment, taken in conjunction with the accompanying drawings, in which like elements have been given like numerals, wherein:

FIG. 1 illustrates a high-level diagram of an exemplary network for providing a network service over a connection using Symmetric High Bit Rate Digital Subscriber Loop (G.SHDSL) as a transport mechanism;

FIG. 2 illustrates a detailed view of an exemplary network using G.SHDSL as a transport mechanism over a network loop connecting to a customer;

FIG. 3 illustrates a block diagram of exemplary components of an access device used in one aspect of the disclosure;

FIG. 4 illustrates a connection enabling remote management of the access device of the present disclosure;

FIG. 5 illustrates a flowchart implementing one aspect of the present disclosure for providing a G.SHDSL connection to a customer location; and

FIG. 6 illustrates a diagram of a machine in the form of a computer system within which a set of instructions, when executed, may cause the machine to perform any one or more of the methodologies of the present disclosure.

### DETAILED DESCRIPTION OF THE DISCLOSURE

The present disclosure provides a system, method and computer-readable medium for providing a network service. In one aspect, the disclosure provides a computer-readable medium accessible to a server for executing instructions contained in a computer program embedded in the computer-readable medium, wherein the computer program includes: a set of instructions to use Symmetric High Bit Rate Digital Subscriber Loop (G.SHDSL) as a transmission standard to transport a network service and a set of instructions to transmit the network service using G.SHDSL over a network loop connecting a network device to a network-capable access device that terminates the network loop at a customer location. The computer-readable medium further includes a set of instructions to change a parameter of operation of the network-capable access device that includes one of: changing a bandwidth of the network-capable access device, synchronizing a clock on the network-capable access device with a network clock, and upgrading software at the network-capable access device. The computer-readable medium further includes a set of instructions to retrieve a parameter related to the network service stored in the network-capable access device, such as bandwidth, volume of data traffic, latency, network availability, network utilization, peak traffic, and test results. The network device is typically a Digital Subscriber Loop Access Multiplexer (DSLAM), and the network loop includes a dry copper pair loop. The network-capable access device is adapted to transfer the network service between a Digital Signal Level 1 (DS-1) connection, typically a DS-1 customer connection, and the network loop and enables at least one of vertical management capabilities, providing remote troubleshooting capabilities, and providing report capabilities at a processor. The network service is at least one of Frame Relay, Ethernet, Asynchronous Transfer Mode, analog voice, Voice over Internet Protocol, and a private line.

In another aspect, the disclosure provides a method of providing a network service that includes using G.SHDSL as a transmission standard to transport the network service and transmitting the network service using G.SHDSL over a network loop connecting a network device to a network-capable access device that terminates the network loop at a customer location. The method further includes changing a parameter of operation of the network-capable access device that includes one of: changing a bandwidth of the network-capable access device, synchronizing a clock on the network-capable access device with a network clock, and upgrading software at the network-capable access device. The method further includes retrieving a parameter related to the network service stored in the network-capable access device, such as bandwidth, volume of data traffic, latency, network availability, network utilization, peak traffic, and test results. In the method, the network device is typically a DSLAM, and the network loop includes a dry copper pair loop. The network-capable access device is adapted to transfer the network service between a DS-1 connection and the G.SHDSL network loop and enables at least one of vertical management capabilities, providing remote troubleshooting capabilities, and providing report capabilities at a processor. The network service is at least one of Frame Relay, Ethernet, Asynchronous Transfer Mode, analog voice, Voice over Internet Protocol, and a private line.

In yet another aspect, the disclosure provides a system for providing a network service that includes a network device for providing the network service using G.SHDSL as a transmission standard over a network loop connected to the network device and a network-capable access device that terminates the network loop at a customer location. The network-capable access device is typically adapted to change a parameter of operation that includes one of: changing a bandwidth of the network-capable access device, synchronizing a clock on the network-capable access device with a network clock, and upgrading software at the network-capable access device. The system further includes a processor for retrieving a parameter related to the network service stored in the network-capable access device. A typical stored parameter may include one of bandwidth, volume of data traffic, latency, network availability, network utilization, peak traffic, and test results. The network device is typically a DSLAM, and the network loop is typically a dry copper pair loop. The network-capable access device is adapted to transfer the network service between a DS-1 connection and the network loop and enables at least one of vertical management capabilities, providing remote troubleshooting capabilities, and providing report capabilities at a processor. The network service is at least one of Frame Relay, Ethernet, Asynchronous Transfer Mode, analog voice, Voice over Internet Protocol, and a private line.

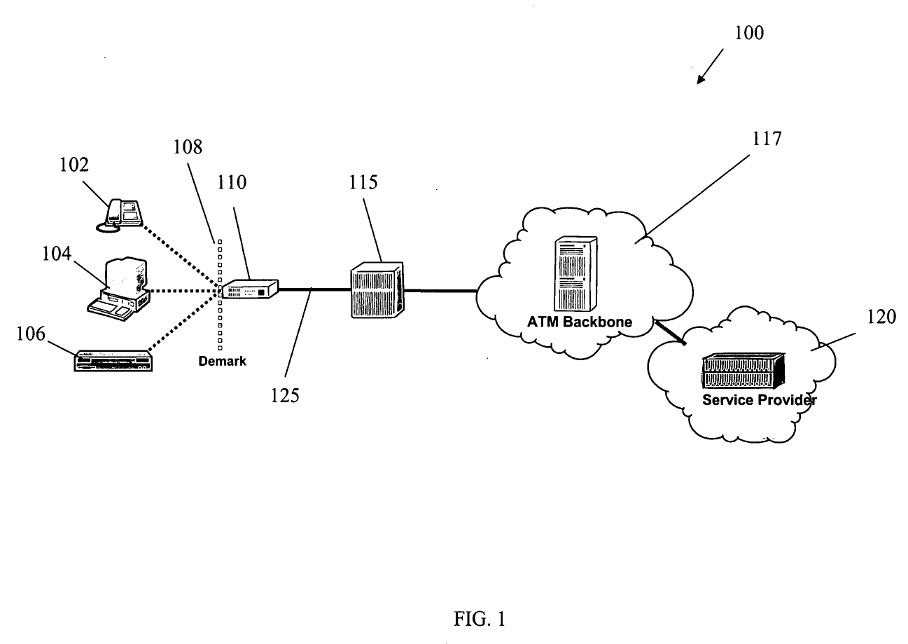

FIG. 1 illustrates a high-level diagram of an exemplary network 100 for providing a network service over a connection using G.SHDSL as a transmission standard. The exemplary network includes an Internet Service Provider (ISP) 120, an Asynchronous Transfer Mode (ATM) backbone 117, a Digital Subscriber Loop Access Multiplexer (DSLAM) 115 and an access device 110 capable of receiving and transmitting a network service using the G.SHDSL transmission standard. The ISP 120 provides various network content, such as Voice over Internet Protocol (VoIP), Internet data, Video on Demand, etc., usable by the various Customer Premises Equipment (CPE), such as telephone 102, computer 104, set-top box 106, etc. The ATM backbone 117 provides a network over which data may be transferred using ATM cells. ATM is a network technology for transferring data in cells or packets of a fixed size instead of variable sized packets as in packet-switched networks (such as the Internet Protocol or Ethernet). An ATM network may provide traffic to an appropriate network, such as IP traffic to an IP network, Frame Relay traffic to a Frame Relay switch, etc.

DSLAM 115 provides connections, such as a DSL connection, to multiple customers. A DSLAM aggregates signals from the multiple customers and separates different signal types, such as voice signals and data signals, onto the appropriate networks, such as a voice network and a data network, respectively. The DSLAM generally terminates a customer connection at a card inserted into one of the multiple slots at the DSLAM. The inserted card enables the transmission standard that is provided to the customer, such as DS-1 or G.SHDSL. A G.SHDSL card inserted into a slot at the DSLAM 115 enables the use of G.SHDSL as a transmission standard over a dry copper pair loop connecting to an access device 110. As used in the disclosure, the DSLAM 115 may operate one or more DS-1 connections and one or more G.SHDSL connections simultaneously. Access device 110 provides an interface between a DSLAM 115 and various CPE (e.g., telephone 102, computer 104, set-top box 106). The access device 110 is located at a customer location and connects to the DSLAM 115 via network loop 125, which is typically a dry copper pair loop, to a G.SHDSL card inserted at the DSLAM, the card enabling G.SHDSL to be used as a transmission standard over the connection.

Demarcation line 108 indicates a point of separation between network devices, such as the access device 110 and the DSLAM 115, and non-network devices, such as the CPE (e.g., telephone 102, computer 104, set-top box 106). As a part of the network infrastructure, the network-capable access device 110 performs several network capabilities. These capabilities include making the access device visible to the network; providing network management, including changing a parameter of operation of the access device; and providing administration of the access device from the network.

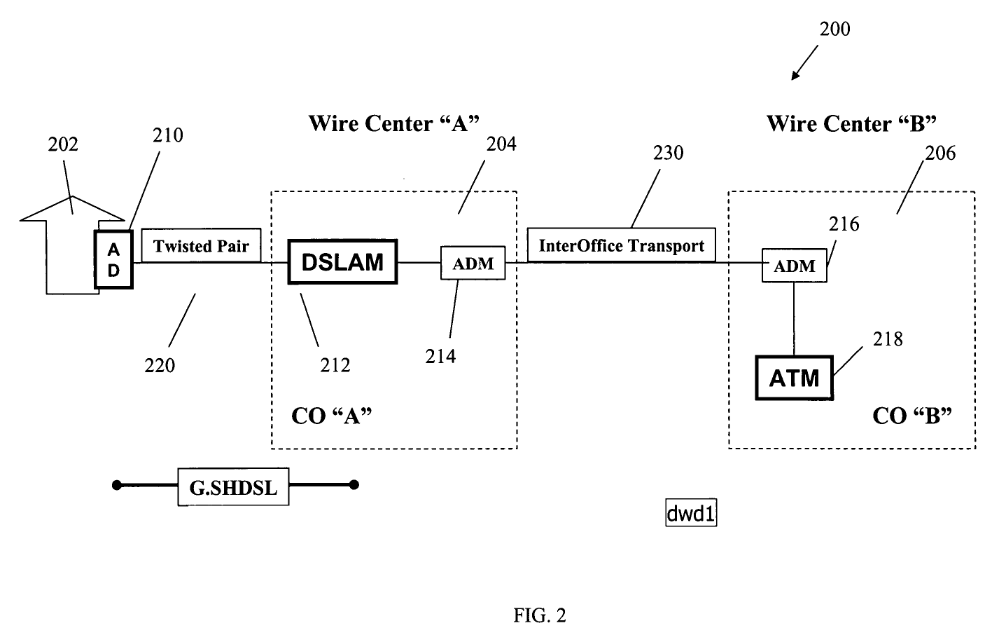

FIG. 2 illustrates a detailed view of an exemplary network 200 using G.SHDSL as a transmission standard over a loop 220 connecting to a customer. The exemplary network architecture includes two wire centers, Wire Center “A” 204 and Wire Center “B,” 206 for transmitting signals between an ATM network switch 218 and multiple customers, such as customer 202, which is often a small to medium-sized business. Wire Center “A”, located at central office “A” (CO “A”) 204, includes various devices that aggregate individual customer connections into a high-speed connection. CO “A” includes an Add/Drop Multiplexer (ADM) 214 for adding and dropping signals traveling at a lower transmission rate to and from a multiplexed signal traveling at a higher transmission rate. The signal traveling at a higher transmission rate may be sent over InterOffice Link 230. CO “A” also includes a DSLAM 212 for aggregating signals from multiple customers, such as customer 202.

Wire Center “B”, located at central office “B” (CO “B”) 206 includes various devices that connect the high-speed connection to an ATM network. These devices include an ADM 216 for adding and dropping signals from the InterOffice Transport line 230 and an Asynchronous Transfer Mode (ATM) switch 218. The ATM switch aggregates traffic from the ADM 216 into ATM cells and transmits the ATM cells to various networks. In the other direction, the ATM switch obtains ATM cells from various networks and delivers the content to the ADM 216.

A network-capable access device 210 residing at a customer location 202 terminates the network loop 220 (using G.SHDSL as a transmission standard) from the DSLAM 212. The network loop 220 may support various telecommunication services, including Frame Relay, Ethernet, ATM, analog voice, Voice over Internet Protocol, and a private line service, for example. At the customer location 202, the access device 210 terminates the G.SHDSL connection 220, converts the service to an appropriate data stream, and hands the data stream off to an appropriate CPE, i.e., phone, computer, set top box. Since the CPE communicate with the access device over a DS-1 connection, the access device converts the service between DS-1 and G.SHDSL transmission standards. The access device 210 further provides functionality that extend network capabilities and network visibility to the customer location 202. In general, the access device supports a single service (i.e., Frame Relay), but it may also support multiple services. For an access device supporting a single service, it is possible to provide an alternative service (i.e., ATM) to the customer by switching the access device suited to the original service with an access device suited to the alternative service. By switching access devices, the type of service provided may be changed without substantially altering the basic network structure shown in FIG. 2.

In operation, a signal from the customer is sent from the access device 210 over a twisted dry cooper pair loop 220 to the central office “A” 204. A dry copper pair loop includes a pair of wires with no voltage, signals, or protocol applied. The two wires that constitute the pair are generally twisted around each other and use G.SHDSL as a transmission standard. DSLAM 212 receives the signal and aggregates the signal with signals received from other customer connections. These aggregated signals are multiplexed into a high-speed connection at the ADM 214 and sent over the InterOffice Transport link 230 to CO “B.” Signals at CO “B” are multiplexed to a higher-speed connection at the ADM 216 and sent to the ATM switch 218.

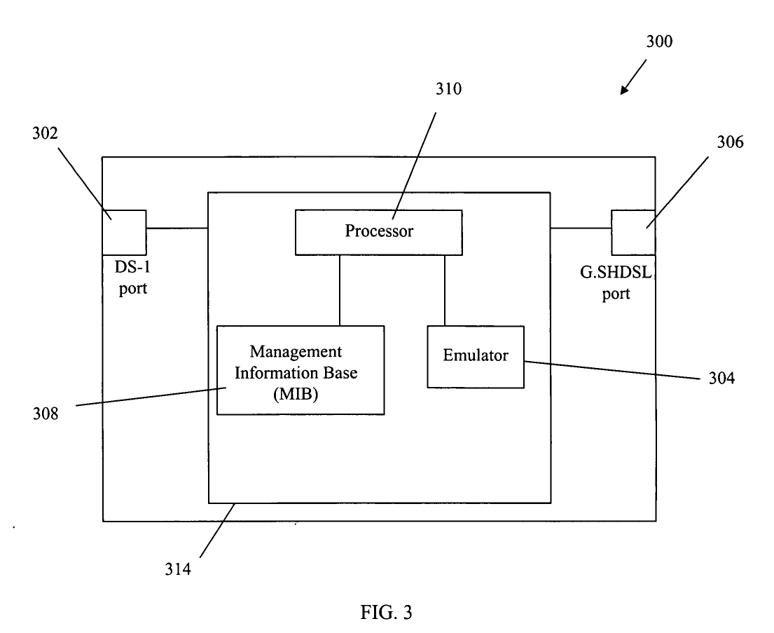

FIG. 3 illustrates a block diagram of exemplary components of an access device 300. The exemplary access device includes a G.SHDSL port 306 for terminating a G.SHDSL connection from a network, and a DS-1 port 302 for providing a DS-1 connection to a device at a customer location. The access device further includes a module 314 located along the connection between the G.SHDSL port 306 and the DS-1 port 302 that performs various functions on the DS-1 data stream and on the G.SHDSL data stream as well as on the operation of the access device. The module 314 includes a Management Information Base (MIB) 308 for storing a parameter (i.e., bandwidth, latency) related to a service, a processor 310 for executing one or more programs, such as a program for data conversion and a program for data transfer, etc, and an emulator 304 that converts data, such as a network service, between transmission standards and provides a DS-1 interface at DS-1 port 302 and a G.SHDSL interface at G.SHDSL port 306. In one aspect, the processor may transfer a network service between a DS-1 transmission standard of the customer connection and the G.SHDSL transmission standard of the network. The processor may use the emulator 304 to provide a DS-1 interface to the customer, convert the network service between the DS-1 and G.SHDSL transmission standards, and provide an interface with the network over a G.SHDSL connection. Data passing between the G.SHDSL port and the DS-1 port passes through module 314.

The Management Information Base (MIB) 308 collects and stores a parameter, such as may be related to a service. Some exemplary parameters may include bandwidth, volume of data traffic, latency, network availability, network utilization, etc. The stored service parameter may be retrieved remotely from the MIB 308 by a device or a processor located at any place within the network. Alternatively, a program running on the processor may send a parameter stored in the MIB to a network device at pre-selected time intervals. The service parameter may be used, for instance, to create customer reports on utilization, latency, network availability, etc. These reports may be viewed by network operations engineers or others to validate that the network is working, to check the performance of the network connection, to determine the amount of usage being generated over the connection, etc. In another aspect, processor 310 may run a program that enables the access device to receive signals from the network to change a parameter of operation of the access device. As an example, the access device may receive a signal causing the access device to change the bandwidth of the service, thereby enabling on-demand sensitivity of the bandwidth to the customer. As another example, the clock of the access device may be synchronized with a network clock. In yet another aspect, the access device may also implement software upgrades sent from the network.

An exemplary access device provides smooth interoperability between Frame Relay and ATM network connections through support for Frame Relay to ATM service interworking, such as the FRF.8.2 standard. The access device also supports a real-time variable bit rate (rt-VBR) service level useful for delivering time-sensitive application such as voice and real-time video; a non-real-time variable bit rate (nrt-VBR) service level useful for bursty traffic, such as Internet traffic; and an unspecified bit rate (UBR) service level that is useful for non-critical data such as file transfers. The UBR service level is commonly used for Internet Protocol (IP) and ATM networks. The access device may support multiple virtual circuits (VCs). The access device provides remotely controlled loop back capabilities to both the network and to customer sides of the access device. These loop back capabilities may be useful for remote testing and diagnostics, among other things. The access device may be detected by the network automatically over a dedicated management channel which may be a permanent virtual circuit between the network and the access device. Also, remote management and administration capabilities, such as downloading software upgrades from the network and changing the bandwidth of the customer connection, may be provided over this dedicated channel.

The access device may provide ASCII text-based menu screens for remotely monitoring, managing, and testing the access device. Typically, this is done remotely from an element management system compatible with the access device or locally using an RJ-45 Ethernet craft access port which is usually labeled and password protected. The access device further provides input and output ports supporting multiple jack standards, such as RJ-11 (analog telephony), RJ-45 (Ethernet), and RJ-48c (DS-1). Timing may be derived through synchronization of an internal clock of the access device with a network clock. Light emitting diodes (LEDs) may be used, for example, to indicate status for access device power, status of the data streams, the status (enabled/disabled) of the loop back to the network, and the status (enabled/disabled) of the loop back to the CPE.

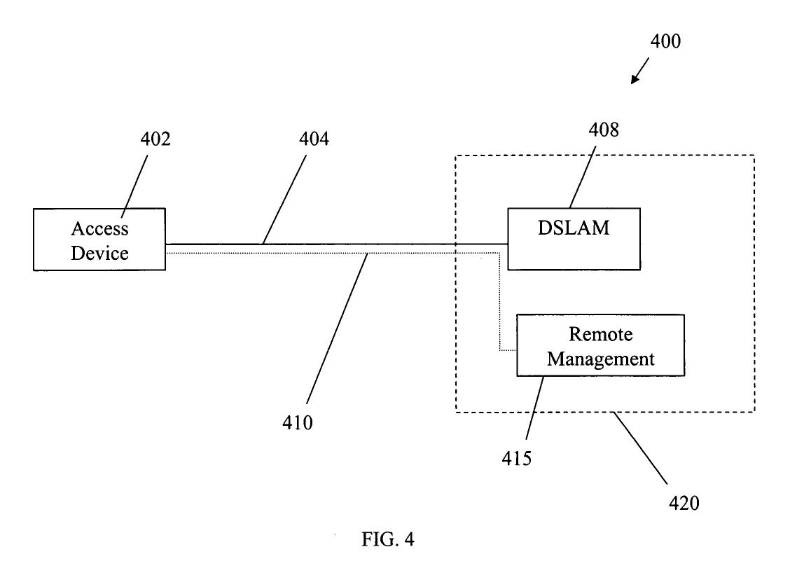

FIG. 4 illustrates a connection 400 enabling remote management of the access device of the present disclosure. Access device 402 is connected to DSLAM 408 over loop 404. Upon installation at the customer location, the access device 402 becomes aware of the network and is automatically detected by a remote management device 415 located at Central Office 420. One or more permanent virtual circuits, such as permanent virtual circuit 410, may be established over the loop 404 between the access device 402 and the remote management device 415 to provide remote management capabilities, such as downloading a parameter of the permanent virtual circuit to the access device, adding a permanent virtual circuit to the access device and synchronizing the clock running at the access device with a network clock.

In the present disclosure, customer traffic flowing from the CPE to the network may be aggregated through use of ATM Inverse Multiplexing (IMA), a protocol for combining multiple low-speed loops into a single high-speed loop. In the exemplary network of FIG. 1, a single dry copper pair loop is used to connect to the network access device 110. To obtain a higher bandwidth using IMA, data streams from multiple dry copper pair loops may be aggregated into a higher-speed data stream (such as 10 Mbit/sec or higher). Multiple loops transmitting data at a lower transmission rate are bonded together to create a single loop transmitting data at a higher transmission rate. For example, four single loops carrying a signal at approximately 2.3 Mbit/sec may be combined to create a single 10 Mbps loop. Loop aggregation may occur, for example, at the access device 110 and at the card inserted into the DSLAM 115. G.SHDSL and IMA protocols are commonly used between the access device 110 and the DSLAM 115.

In the exemplary network of FIG. 1, several services (e.g., IP, ATM, Ethernet) may be transmitted over the entire network from the CPE (i.e. telephone 102, computer 104, set-top box 106, etc.) to the service provider's network or an ISP 120. Other services, such as Frame Relay and voice, may be generally transmitted over circuitry at the customer location. In an exemplary embodiment, the G.SHDSL connection incorporates ATM technology. Packets sent from the customer are converted to ATM at the access device before transmission to the network.

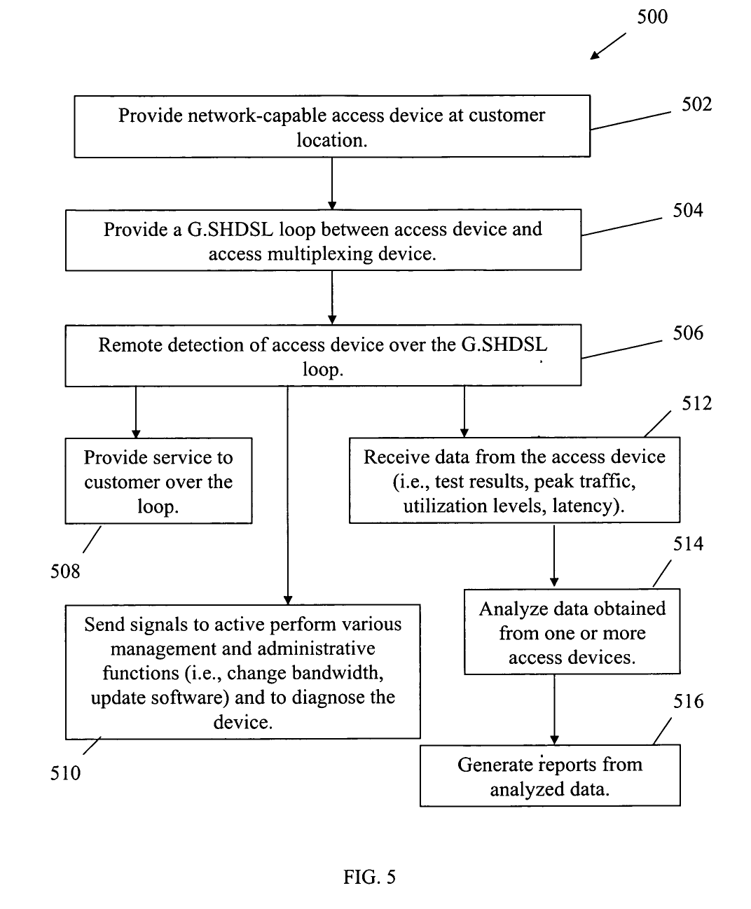

FIG. 5 illustrates a flowchart 500 implementing one aspect of the present disclosure for providing a G.SHDSL network loop to a customer location. An access device capable of performing various network functions is provided at the customer location (Box 502). The network functions may include, for example, access device management, troubleshooting capabilities, data collection capabilities, etc. In Box 504, a loop is provided between the network-capable access device and an access multiplexing device, such as a DSLAM, typically over a dry copper pair loop using G.SHDSL as a transmission standard. In Box 506, the network-capable access device is remotely detected by a program operating at a processor located within the network. Various services are then provided to the network-capable access device using G.SHDSL as a transmission standard (Box 508). These services may include Frame Relay, ATM, Ethernet, analog voice, Voice over Internet Protocol, and private line services, for example. In addition, signals may be sent to the access device from the network (Box 510) to perform various management and administration functions. For example, the bandwidth of the access device may be altered in response to a signal from the network. Also, software updates may be downloaded to the access device. Signals may also be sent from the network to the access device that activates diagnostic tests on the access device. This method of diagnosis saves the cost and effort of sending a technician to the premises. In another aspect of the disclosure, data may be sent from the access device (Box 512) to a network device. Test results, for example, may be sent from the access device to a device on the network. Data (i.e., diagnostic test results, parameters related to the operation of the access device, such as peak traffic, utilization levels, latency, etc.) may be sent in response to a signal from the network or due to a program operating on the access device that may upload data at a scheduled time or on periodic basis. The data received at the network device may be analyzed (Box 514) to determine performance, such as, for example, the bandwidth usage at a single access device, multiple access devices, or throughout the network, for example. The analyzed data may be used to generate reports (Box 516) that may be reviewed by a person such as a network operator.

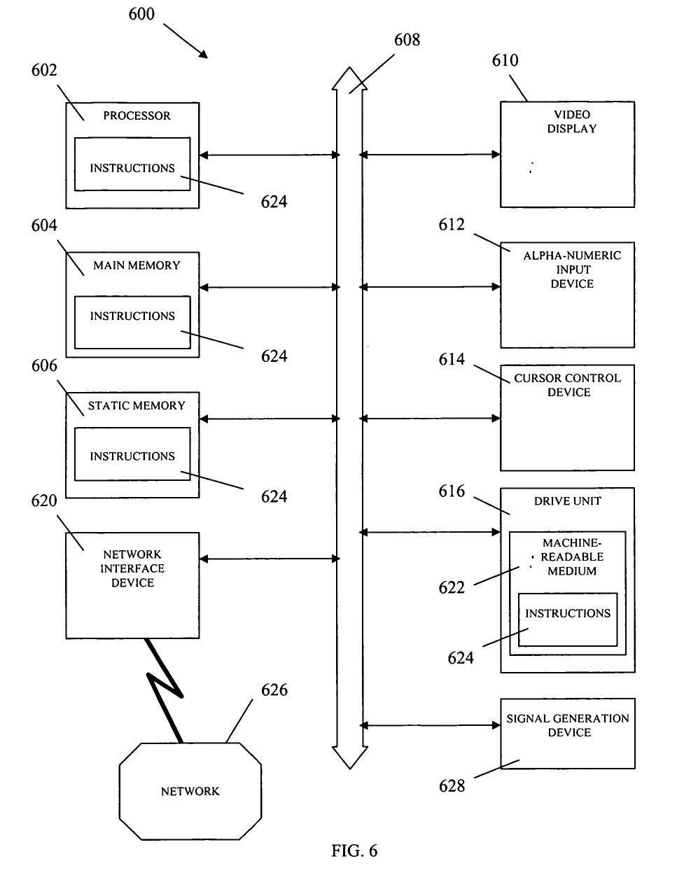

FIG. 6 is a diagrammatic representation of a machine in the form of a computer system 600 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a set-top box (STB), a Personal Digital Assistant (PDA), a cellular telephone, a mobile device, a palmtop computer, a laptop computer, a desktop computer, a personal digital assistant, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 600 may include a processor 602 (e.g., a central processing unit (CPU), a graphics processing unit (GPU), or both), a main memory 604 and a static memory 606, which communicate with each other via a bus 608. The computer system 600 may further include a video display unit 610 (e.g., a liquid crystal display (LCD), a flat panel, a solid state display, or a cathode ray tube (CRT)). The computer system 1000 may include an input device 612 (e.g., a keyboard), a cursor control device 614 (e.g., a mouse), a disk drive unit 616, a signal generation device 618 (e.g., a speaker or remote control) and a network interface device 620.

The disk drive unit 616 may include a machine-readable medium 622 on which is stored one or more sets of instructions (e.g., software 624) embodying any one or more of the methodologies or functions described herein, including those methods illustrated in herein above. The instructions 624 may also reside, completely or at least partially, within the main memory 604, the static memory 606, and/or within the processor 602 during execution thereof by the computer system 600. The main memory 604 and the processor 602 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 624, or that which receives and executes instructions 624 from a propagated signal so that a device connected to a network environment 626 can send or receive voice, video or data, and to communicate over the network 626 using the instructions 624. The instructions 624 may further be transmitted or received over a network 626 via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “disclosure” merely for convenience and without intending to voluntarily limit the scope of this application to any single disclosure or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-readable medium accessible to a server for executing instructions contained in a computer program embedded in the computer-readable medium, the computer program comprising:
a set of instructions to use Symmetric High Bit Rate Digital Subscriber Loop (G.SHDSL) as a transmission standard to transport a network service; and
a set of instructions to transmit the network service using G.SHDSL over a network loop connecting a network device to a network-capable access device that terminates the network loop at a customer location.

2. The computer-readable medium of claim 1, further comprising a set of instructions to change a parameter of operation of the network-capable access device that includes one of: i) changing a bandwidth of the network-capable access device, ii) synchronizing a clock on the network-capable access device with a network clock, and, iii) upgrading software at the network-capable access device.

3. The computer-readable medium of claim 1, further comprising a set of instructions to retrieve a parameter related to the network service stored in the network-capable access device, the parameter including one of: i) bandwidth, ii) volume of data traffic, iii) latency, iv) network availability, v) network utilization, vi) peak traffic, and vii) test results.

4. The computer-readable medium of claim 1, wherein the network device further comprises a Digital Subscriber Loop Access Multiplexer (DSLAM).

5. The computer-readable medium of claim 1, wherein the network loop further comprises a dry copper pair loop.

6. The computer-readable medium of claim 1, wherein the network-capable access device is adapted to transfer the network service between a Digital Signal Level 1 (DS-1) connection and the network loop.

7. The computer-readable medium of claim 1, wherein the network-capable access device enables at least one of: i) vertical management capabilities, ii) providing remote troubleshooting capabilities, and, iii) providing report capabilities at a processor.

8. The computer-readable medium of claim 1, wherein the network service is at least one of: i) Frame Relay, ii) Ethernet, iii) Asynchronous Transfer Mode, iv) analog voice, v) Voice over Internet Protocol, and, vi) private line.

9. A method of providing a network service, comprising:
using Symmetric High Bit Rate Digital Subscriber Loop (G.SHDSL) as a transmission standard to transport the network service; and
transmitting the network service using G.SHDSL over a network loop connecting a network device to a network-capable access device that terminates the network loop at a customer location.

10. The method of claim 9, further comprising changing a parameter of operation of the network-capable access device that includes one of: i) changing a bandwidth of the network-capable access device, ii) synchronizing a clock on the network-capable access device with a network clock, and, iii) upgrading software at the network-capable access device.

11. The method of claim 9, further comprising retrieving a parameter related to the network service stored in the network-capable access device, the parameter including one of: i) bandwidth, ii) volume of data traffic, iii) latency, iv) network availability, v) network utilization, vi) peak traffic, and, vii) test results.

12. The method of claim 9, wherein the network device further comprises a Digital Subscriber Loop Access Multiplexer (DSLAM).

13. The method of claim 9, wherein the network loop further comprises a dry copper pair loop.

14. The method of claim 9, wherein the network-capable access device is adapted to transfer the network service between a Digital Signal Level 1 (DS-1) connection and the network loop.

15. The method of claim 9, wherein the network-capable access device enables at least one of: i) vertical management capabilities, ii) providing remote troubleshooting capabilities, and, iii) providing report capabilities at a processor.

16. The method of claim 9, wherein the network service is at least one of: i) Frame Relay, ii) Ethernet, iii) Asynchronous Transfer Mode, iv) analog voice, v) Voice over Internet Protocol, and, vi) private line.

17. A system for providing a network service, comprising:
a network device for providing the network service using Symmetric High Bit Rate Digital Subscriber Loop (G.SHDSL) as a transmission standard over a network loop connected to the network device; and
a network-capable access device that terminates the network loop at a customer location.

18. The system of claim 17, wherein the network-capable access device is adapted to change a parameter of operation that includes one of: i) changing a bandwidth of the network-capable access device, ii) synchronizing a clock on the network-capable access device with a network clock, and, iii) upgrading software at the network-capable access device.

19. The system of claim 17, further comprising a processor for retrieving a parameter related to the network service stored in the network-capable access device, the parameter including one of: i) bandwidth, ii) volume of data traffic, iii) latency, iv) network availability, v) network utilization, vi) peak traffic, and, vii) test results.

20. The system of claim 17, wherein the network device further comprises a Digital Subscriber Loop Access Multiplexer (DSLAM).

21. The system of claim 17, wherein the network loop further comprises a dry copper pair loop.

22. The system of claim 17, wherein the network-capable access device is adapted to transfer the network service between a Digital Signal Level 1 (DS-1) connection and the network loop.

23. The system of claim 17, wherein the network-capable access device enables at least one of: i) vertical management capabilities, ii) providing remote troubleshooting capabilities, and, iii) providing report capabilities at a processor.

24. The system of claim 17, wherein the network service is at least one of: i) Frame Relay, ii) Ethernet, iii) Asynchronous Transfer Mode, iv) analog voice, v) Voice over Internet Protocol, and, vi) private line.
